(19) United States
(12) Patent Application Publication
(10) Pub. No.: US 2007/0079674 A1
(43) Pub. Date: Apr. 12, 2007

(54) Tool For Removal Of Socket Head Screws Having Stripped Heads

(76) Inventors: Glenn A. Rupp, Highland Lakes, NJ (US); Matthew C. Klimash, Piscataway, NJ (US); Michael A. Passero JR., Roselle Park, NJ (US); Shreedhar Kale, Bensalem, PA (US)

Correspondence Address: ARTHUR L. LESSLER, 540 OLD BRIDGE TURNPIKE, SOUTH RIVER, NJ, 08882, US

(21) Appl. No.: 11/539,628

(22) Filed: Oct. 7, 2006

Related U.S. Application Data
(60) Provisional application No. 60/725,387, filed on Oct. 11, 2005.

(51) Int. Cl. B25B 23/08; B25B 23/10; B25B 13/50

(52) U.S. Cl. 81/441; 81/53.2

(57) ABSTRACT

A tool which has a tip with sharp edges and which is adapted to be inserted into the recess of the head of a stripped socket head screw. Once in the recess the tool is rotated to cause tip edges to bite into the internal wall of the recess, so that enough torque can be applied by the tool to the screw head to rotate the screw out of an object with which it is threadably engaged. In one embodiment the tip has an eccentric camming configuration. In a second embodiment it has a split end configuration with the two parts of the end being slidably movable with respect to each other. In a third embodiment the tip has a helical tapered configuration with a polygonal cross-section having sharp facet edges.

### CROSS-REFERENCE TO RELATED APPLICATION

This application claims the benefit of U.S. Provisional Application Ser. No. 60/725,387 filed Oct. 11, 2005 and entitled Driver For Removal of Screws Having Stripped Heads

### BACKGROUND OF THE INVENTION

The present invention relates to a device for removing socket head screws having stripped heads; and is particularly adapted for, but not limited to, use in orthopedic surgery.

Socket head screws commonly have a noncircular recess in the screw head. Such screws are typically rotated by means of an allen wrench, a torx wrench, or the like. The shape of the recess may become somewhat rounded or otherwise distorted by application of excessive torque to the screw head, or by use of a wrench end which is slightly too small or of the wrong configuration; so that the recess cannot be engaged by the wrench which was designed to remove it, so as to rotate the screw with adequate torque.

In the fastening arts, and especially in orthopedic surgery, removal of stripped socket head screws which are threadably engaged with a parent object such as an artificial joint or rod is a common problem. In the orthopedic surgery field, when a stripped socket head screw is encountered, special techniques are often required to facilitate the removal of the screw.

A common requirement during such surgery is the availability of means to remove the screw which can be effectively used in a limited space. An important requirement during surgery is that essentially no debris be produced during the removal process.

Various tools and methods have been developed in an effort to facilitate the removal of stripped socket head screws, particularly in orthopedic surgery, while meeting the aforementioned requirements. These known methods are either inadequate or cumbersome, or involve chipping of the screw metal or the need for a substantial amount of space in the region of the screw head, or create debris.

For example, in one method for removing a stripped socket head screw in orthopedic surgery, an end of a screwdriver shaft is glued with an adhesive to the exposed end of the screw to be removed. The screw is driven out after the adhesive dries. This method has the disadvantages of introducing a foreign material to living tissue adjacent the surgery site, and having its likelihood of success limited by the strength of the adhesive, so that screws under a high amount of tension are very hard to remove.

In another stripped socket head screw removal method for use in orthopedic surgery, the tip of a screwdriver shaft or another object is welded to the head of the screw to be removed. However, welding is not recommended in a surgical environment. Welding generates a lot of heat which could be harmful to the parent component. In addition, the screwdriver, if welded to the screw head, cannot be salvaged and reused.

According to another prior art method, the stripped socket head screw head is drilled off. and if there is any part of the screw shank still protruding, a slot is cut into the shank so that a flat head screw driver can be used to remove the screw. This method has the disadvantage of generating debris which may contaminate the surgical site.

According to still another prior art method, after drilling the screw head off, if there is no portion of the shank protruding above the parent surface, a pilot hole is drilled in the shank and then a reverse threaded tool known as an easy-out is used to remove the screw. This method runs the risk of damaging the parent component adjacent the screw, since the drilling operation necessarily is performed very close to the parent component. This method also produces debris with the accompanying risk of surgical site contamination.

Accordingly, an object of the present invention is to provide an improved threaded fastener removal tool which is particularly adapted for use with the aforementioned types of fasteners in a limited space near the fastener head or end, and which produces essentially no debris during the removal process.

### SUMMARY OF THE INVENTION

As herein described, there is provided a tool for removing a socket head screw having a stripped head from a parent object with which the screw is threadably engaged. The tool has a tip adapted to press into the internal wall of the recess in the head of the screw while the tip is rotated, so as to apply sufficient torque to rotate the screw in a direction to remove it from the parent object.

In a first embodiment the tip has multiple cutter like segments and is eccentrically rotatably mounted to the tool, so that when the tip is rotated some of the edges move radially outward to engage the internal wall of the head recess of a screw to be removed, enabling enough torque to be applied to remove the screw.

In a second embodiment the tip end is split and the tool is in the form of pliers which can be moved to cause the tip portions to slide with respect to each other so that one end of one tip portion moves away from an opposite end of the other tip portion, and those ends press against the inner wall of the screw head recess to enable sufficient torque to be applied to the screw to remove it.

In a third embodiment the tip has a helical tapered shape with a polygonal cross-section having facet edges adapted to engage the internal wall of the recess in the head of the screw. Rotation of the tool causes the tip to solidly engage the internal wall so that the torque required to remove the screw can be applied.

### IN THE DRAWING

FIG. 1A is an isometric view of a camming type stripped socket head screw removal tool according to a first embodiment of the invention.

FIG. 1B is an isometric view of the cam tip of the tool shown in FIG. 1A.

FIG. 2 is an exploded isometric view of the cam tip shown in FIG. 1B.

FIG. 3A is a cross-sectional view of the cam tip shown in FIGS. 1B and 2, inserted into the head recess of a stripped socket head screw to be removed, taken along the cutting plane FIG. 3A-FIG. 3A shown in FIG. 3B.

FIG. 3B is an end view of the cam tip shown in FIGS. 1A, 1B and 3A, disposed within the head recess of the socket head screw to be removed.

FIG. 4A is an end view of the cam tip shown in FIGS. 1A, 1B, 3A and 3B, disposed within the head recess of the socket head screw to be removed, with the cam element in engagement with the internal wall of the head recess.

FIG. 4B is a cross-sectional view of the cam tip shown in FIGS. 1A, 1B, 3A, 3B, and 4A inserted into the head recess of the socket head screw shown in FIG. 4A, taken along the cutting plane FIG. 4B-FIG. 4B shown in FIG. 4A.

FIG. 5A is an isometric view of a split tip pliers type stripped socket head screw removal tool according to a second embodiment of the invention.

FIG. 5B is an isometric view of the split tip of the tool shown in FIG. 5A.

FIG. 6A is an isometric view of the split tip of the tool shown in FIGS. 5A and 5B, inserted in the head recess of a stripped socket head screw to be removed.

FIG. 6B is an isometric view of the split tip of the tool shown in FIGS. 5A, 5B and 6A, inserted in the head recess of a stripped socket head screw to be removed, wherein the handles of the tool have been rotated relative to each other to cause opposite edges of the split tip to engage the internal wall of the head recess.

FIG. 6C is an end view of the split tip and fastener shown in FIG. 6A.

FIG. 6D is an end view of the split tip and fastener shown in FIG. 6B.

FIG. 7A is an isometric view of an alternative gripping tip of the stripped socket head screw removal tool shown in FIG. 1A, according to a third embodiment of the invention which represents the best mode thereof.

FIG. 7B is a side elevation view of the end portion of the gripping tip shown in FIG. 7A.

FIG. 7C is a cross-sectional view of the gripping tip shown in FIG. 7B, taken along the cutting plane FIG. 7C-FIG. 7C.

FIG. 7D is a cross-sectional view of the gripping tip shown in FIG. 7B, taken along the cutting plane FIG. 7D-FIG. 7D.

FIG. 8 is a partially cross-sectional view of the gripping tip shown in FIG. 7A in engagement with the internal wall of the head recess of a socket head screw to be removed.

### DETAILED DESCRIPTION

### First Embodiment

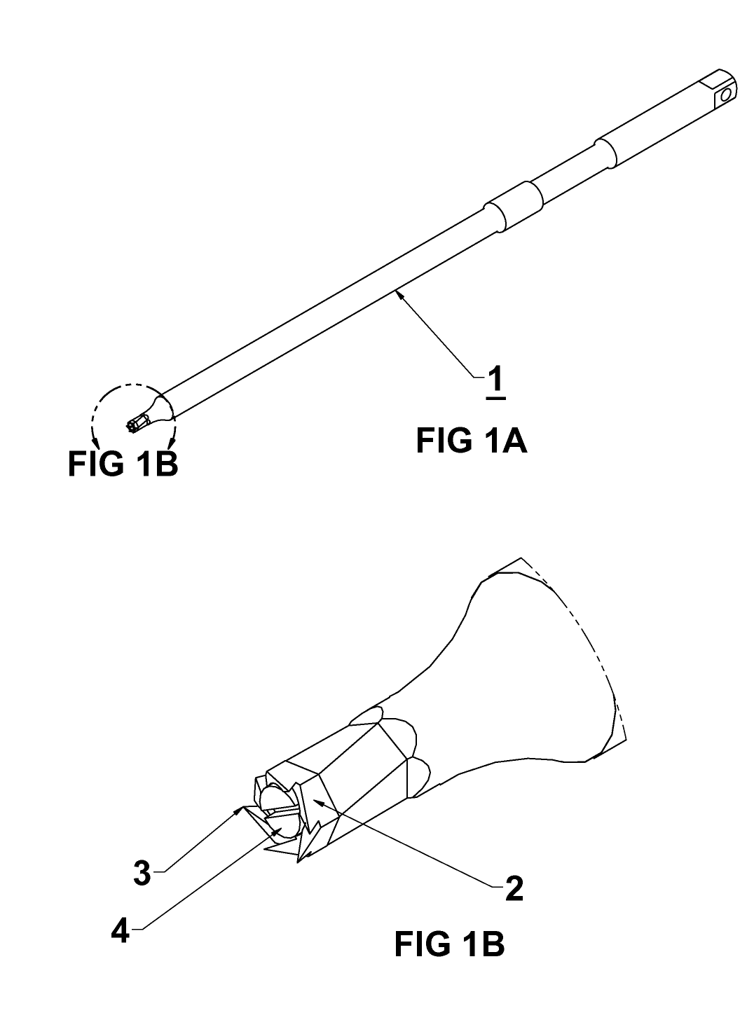

The camming tip screw removal tool 1 shown in FIGS. 1A through 4B operates in such a way that when its camming tip 2 is inserted in the head recess 7 of a stripped socket head crew 7 and rotated in a direction to remove the screw from the parent object it is threaded into, the tip wedges against the internal wall of the recess to firmly grip the screw so that it can be unscrewed from the parent object.

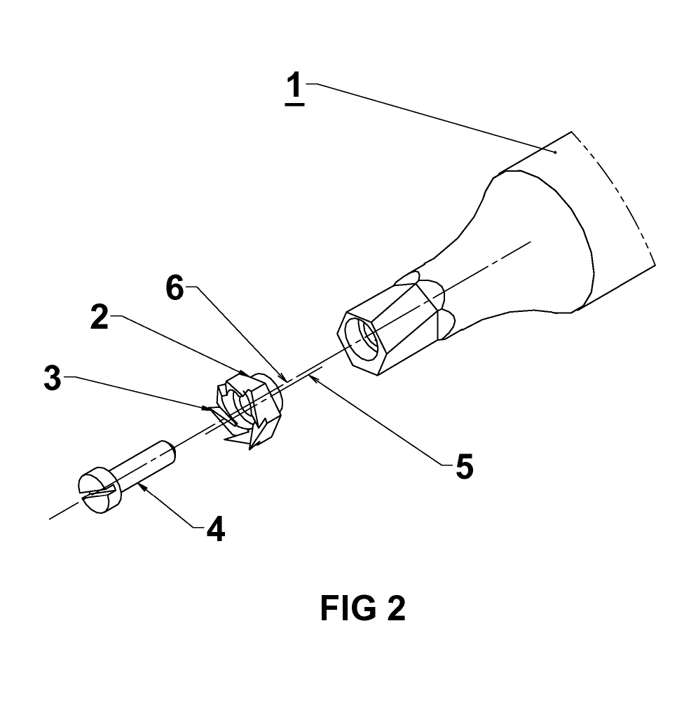

The cam tip 2 has protruding sharp edged cutter like segments 3 which comprise camming hexagonal faces, and is eccentrically secured to the adjacent end of the tool 1 by a fastener 4. That is, the longitudinal axis 5 of the cam 2 is offset from the longitudinal axis 6 of the tool and the camming tip 2 is rotatable with respect to the body of the tool 1, as best seen in FIG. 2.

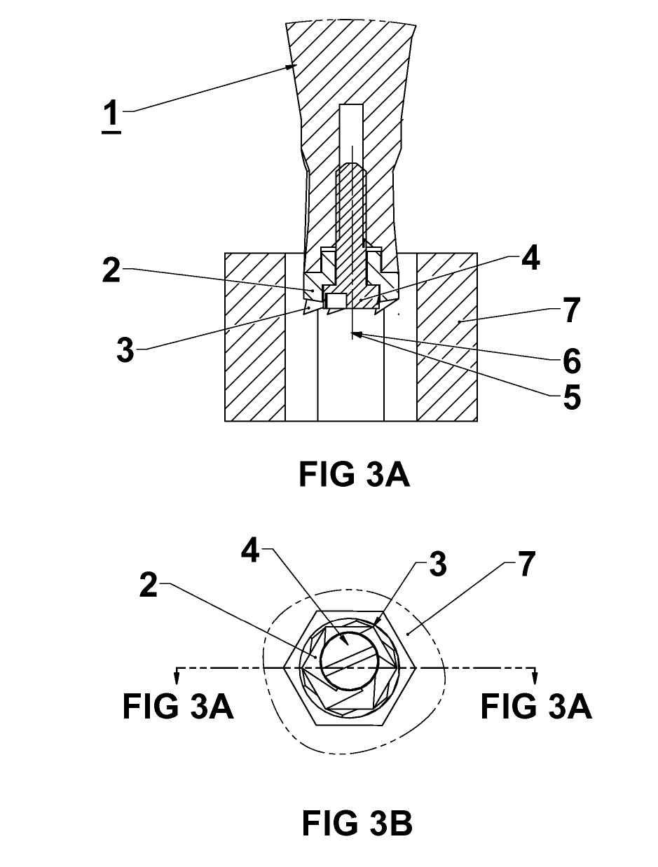

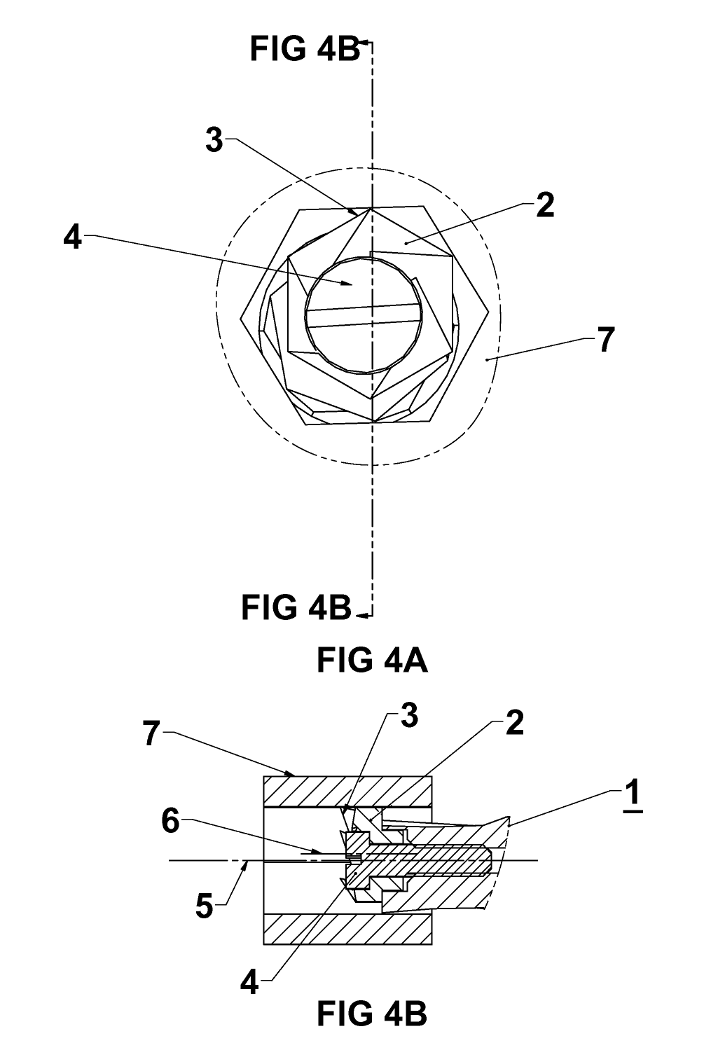

As shown in FIG. 3A, the tool is used by rotating the tip to a position where its radial extension away from the tool axis 5 is minimal, and inserting the tip 2 into the head recess 7 of the screw to be removed. Then the tool 1 is rotated by means of a ratchet or wrench coupled to the remote end of the tool shaft, in a direction to remove the screw head 7 from the parent object, causing the cutter like tip 2 to engage the internal wall of the recess in the screw head 7 as shown in FIG. 4B; resulting in an outward movement of some of the tip segments so that those segments engage and bite into the inner wall of the screw head recess to transmit sufficient torque to remove the screw head 7 and the screw of which it is a part.

### Second Embodiment

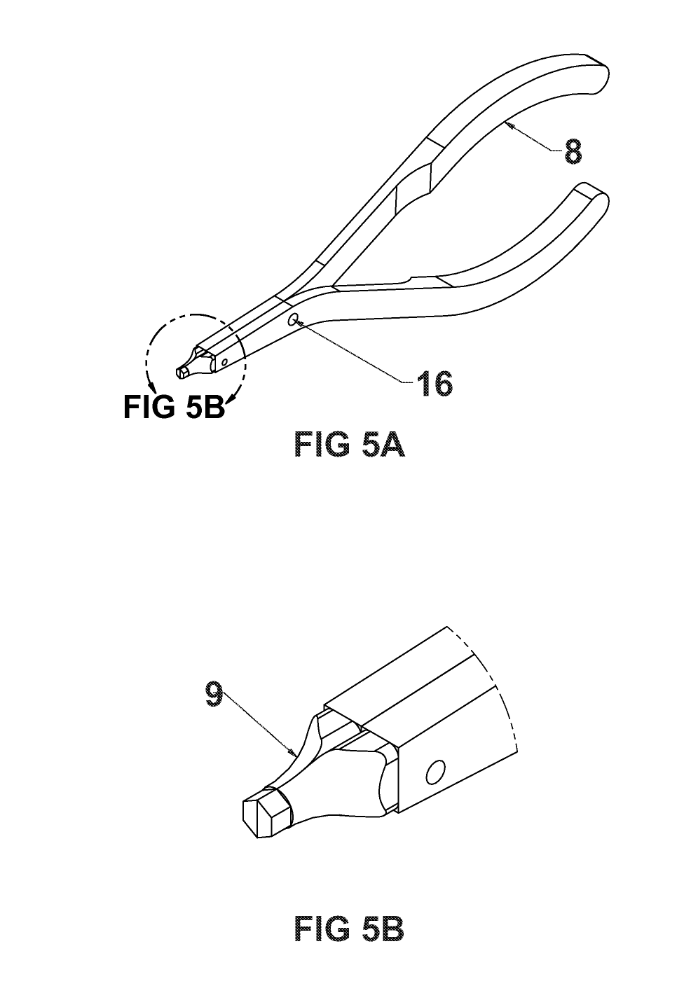

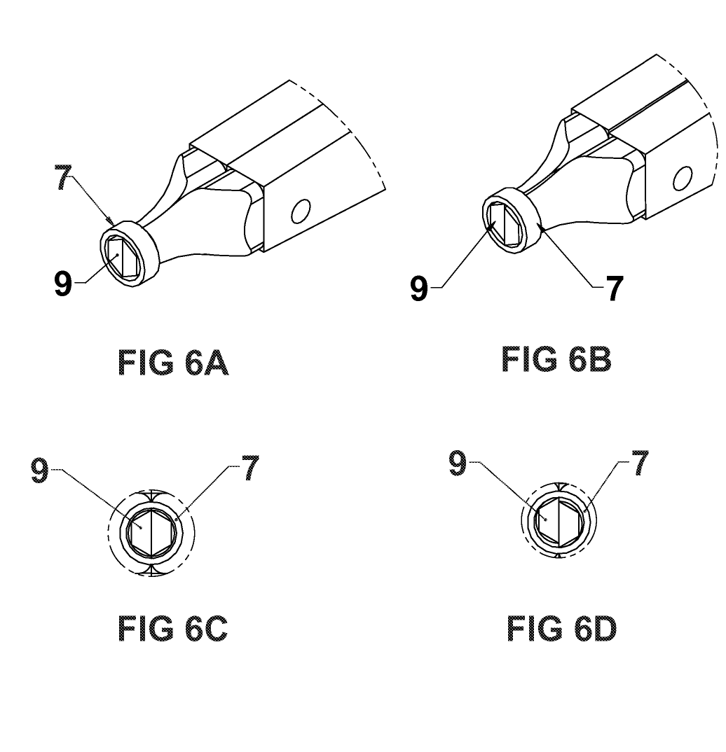

The split tip pliers 8 shown in FIG. 5A through 6D operates to slide the two portions of the tip 9 against each other when the plier handles are moved relative to each other, so that the upper edge of one portion is displaced away from the lower edge of the other portion, as best seen in FIGS. 6B and 6D. That is, as best seen in FIG. 5A, movement of the plier handles causes rotation thereof about the pin 16 located near where the handles diverge from each other, and consequent sliding of the tip portions with respect to each other.

FIG. 6C shows the front view of the pliers tips 9 in the closed configuration, where the tip portions are in juxtaposition such that their top and bottom ends are in alignment with each other. The aligned tips are then inserted into the stripped head recess of a screw 7 to be removed, as also shown in FIG. 6C.

The handles of the pliers are then moved to rotate the same about the pliers pin until the upper edge of one portion of the split tip 9 engages the internal wall of the head recess of the stripped screw head 7 and the lower edge of the other portion of the tip engages an opposite part of the head recess, as shown in FIGS. 6B and 6D. This action results in the overall vertical dimension of the tip increasing, and the opposite edges of the tip portions engaging the internal wall of the head recess of the screw. Torque is then be applied to rotate the pliers 8 and screw head 7 in a direction to remove the screw, while pressing holding the plier handles away from each other with sufficient force to maintain the tip portions in engagement with the internal wall of the head recess so as to transmit sufficient torque to remove the stripped screw.

### Third Embodiment (Best Mode)

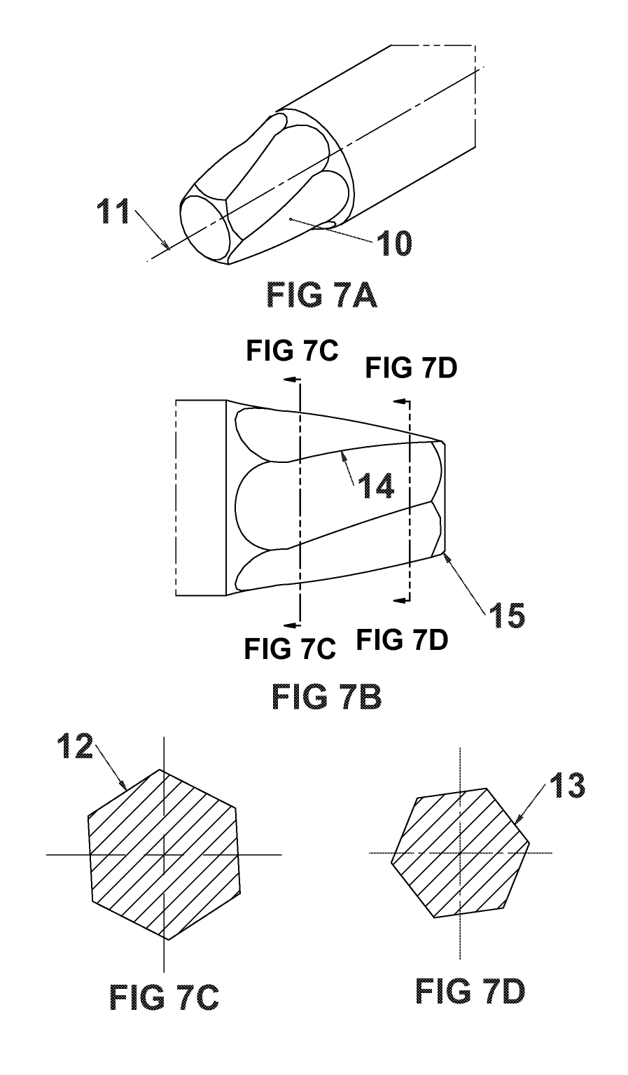

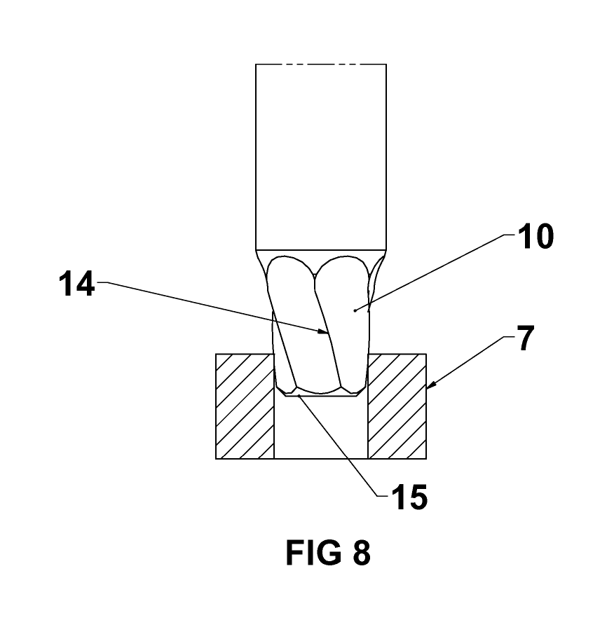

The tapered helical tip 10 for the tool 1, as shown in FIGS. 7A through 8, has multiple sharp edges which bite into the internal wall of the recess in the head 7 of a stripped socket head screw so that sufficient torque can be applied by the tool to rotate the screw head and screw so as to remove it from the parent object with which the screw is threadably engaged.

The tip 10 has a twisted or helical tapered polygonal configuration with multiple edges, such that successive cross-sections are polygons rotated with respect to each other, a hexagonal polygonal configuration being shown in FIGS. 7A through 8, and two such cross-sections being shown in FIGS. 7C and 7D. The tapered edges 14 are preferably sharp transitions between the facets of the tapered faces of the tip.

The tapered helical polygonal configuration of the tool tip 10 has a chamfered section 15 adjacent the distal end of the tip which facilitates insertion of the tip into the recess of the head 7 of the screw to be removed.

As the tip 10 is inserted into the recess of the head 7 of the screw as shown in FIG. 8, it is guided by the helical edges 14 until the tip is fully seated in the screw head recess, at which time the engagement of the tip and the internal wall of the screw head recess is sufficient to transmit the torque necessary to remove the stripped screw when the tool 1 is rotated.

I claim:

1. A tool for removing a socket head screw having a stripped head from a parent object with which the screw is threadably engaged, comprising:
a shaft having a driven end adapted to be rotated and a driving end;
a camming tip rotatably attached to the driving end of the shaft, said tip being eccentrically mounted to the shaft,
said tip having a plurality of protruding cutter like segments, so that the sharp edges of said segments move radially outward and inward as the tip is rotated with respect to the shaft,
said tip being dimensioned to fit within the head recess of the screw when said outer edges are disposed radially inward, so that portions of said outer edges engage the internal wall of said head recess when said edges are moved radially outward,
whereby said screw can be removed by positioning said tip within said recess and rotating said tool shaft in a direction to remove the screw from said parent object so that portions of said outer edges of said tip engage said recess wall to transmit torque to said screw head to cause the screw to rotate out of said object.

2. A split tip pliers tool for removing a socket head screw having a stripped head from a parent object with which the screw is threadably engaged, comprising:
split tip pliers having two juxtaposed handles rotatably coupled to each other, each handle having a grip end and a tip end,
each tip end having an upper and a lower edge,
said pliers having a closed position wherein the tip ends have their upper and lower edges substantially in mutual alignment, and an open position wherein the distance between the upper edge of one tip end and the lower edge of the other tip end is increased;
so that when said pliers is in a closed position said aligned tip ends can be inserted into the head recess of said socket head screw and when said pliers is thereafter opened the upper edge of one tip end and the lower edge of the other tip end engage opposite parts of the internal wall of the head recess of said screw to enable said screw to be removed from said parent object by rotating the handles of said pliers.

3. A tool for removing a socket head screw having a stripped head from a parent object with which the screw is threadably engaged, comprising:
a shaft having a driven end adapted to be rotated and a driving end;
a tapered helical tip disposed at the driving end of the shaft,
said tip having a polygonal cross-section with facet edges adapted to engage the internal wall of the recess in the head of said screw,
so that when the tip is urged against the screw head to engage said facet edges with said wall, sufficient torque can be applied by the tool to rotate the screw head and screw so as to remove it from the parent object with which the screw is threadably engaged.

4. The tool according to claim 3, wherein said tip has a chamfered section adjacent the distal end thereof.

5. A tool for removing a socket head screw having a stripped head from a parent object with which the screw is threadably engaged, comprising tip means adapted to press into the internal wall of the recess in the head of said screw while said tip is rotated, so as to apply sufficient torque to rotate said screw in a direction to remove it from the parent object.
